(19) United States
(12) Patent Application Publication
(10) Pub. No.: US 2004/0046703 A1
(43) Pub. Date: Mar. 11, 2004

(54) Device and method for protecting against the possible adverse health effects of electromagnetic radiation emissions

(76) Inventors: Takuji Hatanaka, Yukuhashi-City (JP); Hideo Seki, Tokyo (JP); Norio Seki, Tokyo (JP)

Correspondence Address: FISH & NEAVE, 1251 AVENUE OF THE AMERICAS, 50TH FLOOR, NEW YORK, NY, 10020-1105, US

(21) Appl. No.: 10/237,906

(22) Filed: Sep. 6, 2002

(51) Int. Cl. H01Q 1/52; H01Q 1/24

(52) U.S. Cl. 343/841; 343/702

(57) ABSTRACT

A radiation protection device for minimizing the deleterious effects of electromagnetic radiation, especially that from a cellular telephone is presented. The radiation protection device is preferably composed of a ceramic material. Upon affixing the radiation protection device to a cellular telephone or any suitable electronic device, the radiation protection device absorbs gravitational waves from the surrounding environment. The absorbed gravitational waves may be amplified within the radiation protection device. The radiation protection device may then emit the amplified gravitational waves to alter the electromagnetic radiation emitted from the cellular telephone.

### BACKGROUND OF THE INVENTION

This invention relates to devices and methods for protecting against possible adverse health effects of electromagnetic radiation emissions. More particularly, this invention relates to a gravitational wave generation device that minimizes any potential deleterious effects of electromagnetic radiation emitted from electronic devices, such as a cellular telephone.

With the advent of cellular telephones, handheld computing devices, and other electronic devices, humans are being exposed to a greater amount of electromagnetic radiation. Chronic exposure to electromagnetic radiation may cause certain illnesses, such as cancer, leukemia, Parkinson's disease, and Alzheimer's disease. Studies have also shown that extended exposure to electromagnetic radiation, especially that generated by cellular telephones, may interfere with vital electron-dependent biophysical life processes (e.g., adenosine triphosphate (ATP) synthesis), break DNA strands in brain cells, and cause memory loss.

However, regulatory authorities have been slow to respond to such studies. For example, the latest government advice is to adopt a precautionary principle towards cell phone exposure. In another example, some authorities have set a predetermined limit on the amount of electromagnetic radiation that can be emitted by a cellular telephone.

Meanwhile, an increasing number of manufacturers have produced speaker and microphone assemblies for reducing a user's exposure to electromagnetic radiation generated by a cellular telephone. However, recent studies have shown that such assemblies do not reduce radiation near the user's head and can themselves be a source of electromagnetic radiation. Other manufacturers have produced deflective or protective devices also aiming to protect against electromagnetic radiation from a cellular telephone. However, many of these devices degrade the performance of cellular telephones when using such devices.

In view of the foregoing, it would be desirable to provide a method and device that minimizes possible deleterious effects of electromagnetic radiation, especially that from a cellular telephone.

It would also be desirable to provide an electromagnetic radiation protection device that is easily installed, lightweight, economical, and does not significantly affect the performance of the electronic device to which it is attached.

### SUMMARY OF THE INVENTION

It is an object of this invention to provide a method and device that minimizes potential deleterious effects of electromagnetic radiation, especially that from a cellular telephone.

It is also an object of this invention to provide an electromagnetic radiation protection device that is easily installed, lightweight, economical, and does not significantly affect the performance of the electronic device to which it is attached.

In accordance with this and other objects of the invention, a device and method for minimizing potential deleterious effects of electromagnetic radiation by generating gravitational waves is provided.

In a preferred embodiment of the invention, the radiation protection device is preferably composed of a ceramic material. Upon affixing the radiation protection device to a cellular telephone, the radiation protection device absorbs gravitational waves from the surrounding environment. The absorbed gravitational waves may be amplified within the radiation protection device. The radiation protection device may then emit the amplified gravitational waves to alter the electromagnetic radiation emitted from the cellular telephone. It should be noted that the radiation protection device may also be used with any other suitable electronic device, such as, for example, a personal computer, a palmtop computer, a laptop computer, a personal digital assistant (PDA), or a television.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is an illustrative representation of a graviton;

FIG. 2 is a front view of an illustrative cellular telephone according to the invention;

FIG. 3 is a back view of an illustrative cellular telephone having radiation protection devices according to the invention;

FIG. 4 is a schematic diagram of an embodiment of an apparatus for testing the viability of human peripheral blood lymphocytes under various exposure conditions according to the invention

FIG. 5 is a microscopic image of viable and non-viable human peripheral blood lymphocytes that have been examined using a Trypan Blue exclusion assay according to the invention

FIG. 6 is a bar graph showing the viability of human peripheral blood lymphocytes after the various exposure conditions.

### DETAILED DESCRIPTION OF THE INVENTION

The invention provides a device and method for minimizing possible deleterious effects of electromagnetic radiation, especially the electromagnetic radiation from cellular telephones, by generating gravitational waves.

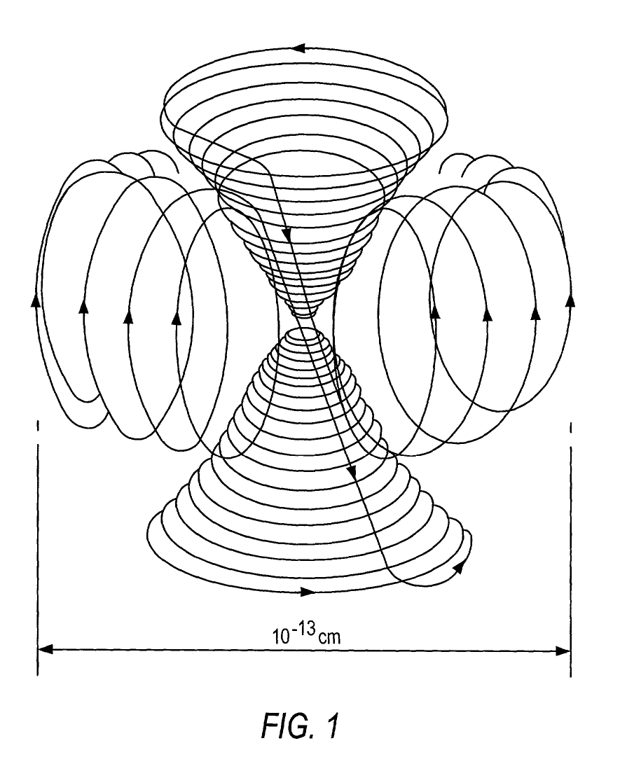

Gravity is one of the most familiar fundamental forces of nature. A gravitational force is an attractive force between all objects that have mass and is responsible for effects as seemingly diverse as an apple falling to the earth and the orbital motion of a planet around the sun. The fundamental particle that accompanies the gravitational force is known as a “graviton.” A graviton has no mass or charge and carries the force of gravity. A graviton may be represented by an upside-down truncated cone and a truncated cone. A typical graviton is shown in FIG. 1.

It is believed that one or more gravitons reside in a single quark. When a graviton leaves the quark, gravitational waves are generated. Gravitational waves are disturbances in the curvature of space-time caused by the motions of matter. Though gravitational waves pass straight through matter, the strength of these waves weaken proportionally to the distance traveled from the source.

In many ways, gravitational waves are similar to electromagnetic waves (e.g., light, radio, microwave, etc.), which are produced when a charged particle is accelerated. Gravitational waves occur when a mass is accelerated or decelerated. However, unlike electromagnetic waves which tend to be modified by matter it passes through, it should be noted that gravitational waves remain unchanged by matter they pass through (i.e., unaffected by scattering or absorption due to intervening matter).

The existence of gravitational waves has been confirmed experimentally. For example, in the 1970s, researchers observed such gravitational waves in the gradual slowing of the rotation of a binary pulsar system (i.e., PSR1913+16).

Gravitons and gravitational waves are further discussed in Hideo Seki et al., Kokorowa Uchuno Kagami (translated as The Mind is a Mirror of the Universe), Seiseishuppan Ltd., September 2000 and Hideo Seki, Gravitonics, Kasoku Gakuen Ltd., August 2000, which are both hereby incorporated by reference herein in their entireties.

In accordance with the invention, a radiation protection device and method are provided for minimizing possible deleterious effects of electromagnetic radiation by generating gravitational waves.

Although the radiation protection device is described herein as being configured on a cellular telephone, this is only illustrative. The radiation protection device may also be configured on any suitable electronic device, such as, for example, a personal computer, a palmtop computer, a laptop computer, a personal digital assistant, or a television.

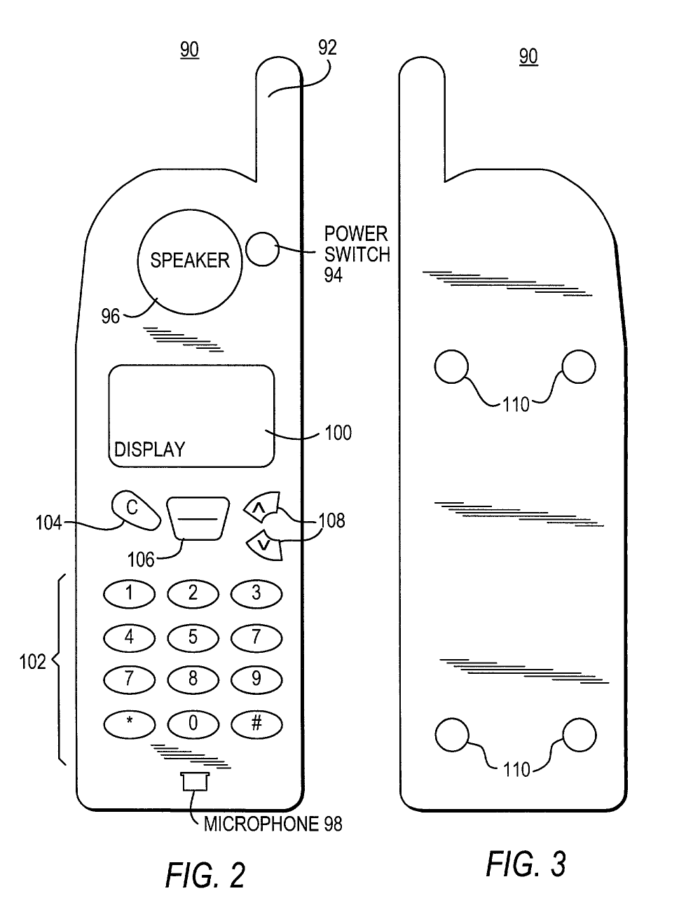

FIGS. 2 and 3 show a front view and a back view, respectively, of an illustrative cellular telephone 90 with which the radiation prevention device may be used. Cellular telephone 90 may have an antenna 92 to support any suitable wireless communications. Cellular telephone 90 may include a power switch 94 which may be used to turn on and off cellular telephone 90. Cellular telephone 90 may also include a speaker 96 that allows a user to hear conversations and a microphone 98 that allows the user to converse with others. Cellular telephone 90 may further include a display 100. Display 100 may be a liquid crystal display (black and white or color), a plasma display, a light-emitting diode display, an active matrix display, or any other suitable type of display.

Cellular telephone 90 may also include a plurality of keys, thereby allowing the user to enter inputs. For example, numeric keys 102 may allow the user to enter a telephone number. If desired, some of the numeric keys 102 may perform secondary functions if, for example, they are pressed and held for at least a predetermined length of time. Clear key 104 may be used to clear characters from display 100. Navigation key 106 may be used to access menus, make telephone calls, etc. Scroll keys 108 may be used to scroll through menus and to scroll through other items presented on display 100.

One or more radiation protection devices 110 may be affixed to cellular telephone 90. As shown in FIG. 3, radiation protection device 110 is preferably affixed to each corner of cellular telephone 90. Radiation protective device 110 preferably has a diameter of about 4 mm and a depth of about 2 mm. Device 110 is also preferably composed of a ceramic material. Ceramic materials may include, for example, a piezoelectric ceramic or a ceramic ferrite.

In some embodiments, a binding agent may be applied to affix devices 110 to cellular telephone 90. The binding agent may be any suitable substance, such as, for example, a resin, a glue, an epoxy, a light activated epoxy, a tar, a cross-linking polymer, a thermoplastic polymer, a thermosetting, polymer, polyurethane, polyacrylic, natural rubber latex, styrene butadiene, acrylic/acrylonitrile copolymer, modified n-butyl acrylonitrile copolymer, acrylonitrile polyvinyl acetate, polyacrylate, acrylonitrile butadiene, acrylic methyl methacrylate, self cross linking copolymers of vinyl acetate and ethylene, polystyrenes, polyesters, polyvinyl alcohol, polyvinyl acetate, vinyl chloride copolymers, melamine-formaldehyde resins, or any suitable combinations of the above (provided that each component of the combination is compatible with each other component). However, it should also be noted that devices 110 may be removable from cellular telephone 90.

In some embodiments, radiation protection devices 110 may be incorporated into the body of cellular telephone 90. For example, devices 110 may be built into the battery casing (not shown) of cellular telephone 90. In another example, cellular telephone 90 may have built-in depressions (not shown) into which devices 110 may be affixed such that affixed devices 110 are flush with the surface of cellular telephone 90.

In response to affixing devices 110 to cellular telephone 90, devices 110 may protect the human body against possible adverse effects of electromagnetic waves emitted by cellular telephone 90. Upon affixing the radiation protection device 110 onto cellular telephone 90, device 110 absorbs gravitational waves from the surrounding environment. The absorbed gravitational waves are amplified within the radiation protection device 110. The radiation protection device 110 may then emit the amplified gravitational waves, which are vertical waves, to alter the electromagnetic radiation emitted from cellular telephone 90. The amplified gravitational waves filter out minus gravitational waves (i.e., which carry electromagnetic waves), thereby protecting the human body against possible adverse effects of electromagnetic waves emitted by cellular telephone 90.

In order to investigate whether device 110 protects the human body against electromagnetic waves, the viability of human peripheral blood lymphocytes was examined using a Trypan Blue exclusion assay following a nine hour exposure to a cellular telephone (charged and set on standby). While any suitable cell model may be used, the cell model used is preferably the human peripheral blood lymphocyte which is readily available and has a well-characterized importance to a human's immune system against infection and tumor oncostasis. Lymphocytes are complex white blood cells that direct the body's immune system. It should be noted that lymphocytes differ from other types of white blood cells because lymphocytes can recognize and have a memory of invading bacteria and viruses. Therefore, it is appropriate to use the human peripheral blood lymphocytes as a model in evaluating the protective effect against electromagnetic radiation.

Human peripheral blood lymphocytes were isolated from a healthy sixty year old male via venipuncture of vena cubitale into anticoagulated vacutainers (Becton Dickinson, EDTA, K3), transported into four 2 ml sterile vials, and differentially centrifuged at 450 g. A culture medium (RPMI-1640 plus antibiotics and antimycotics) was also added to each of the four vials.

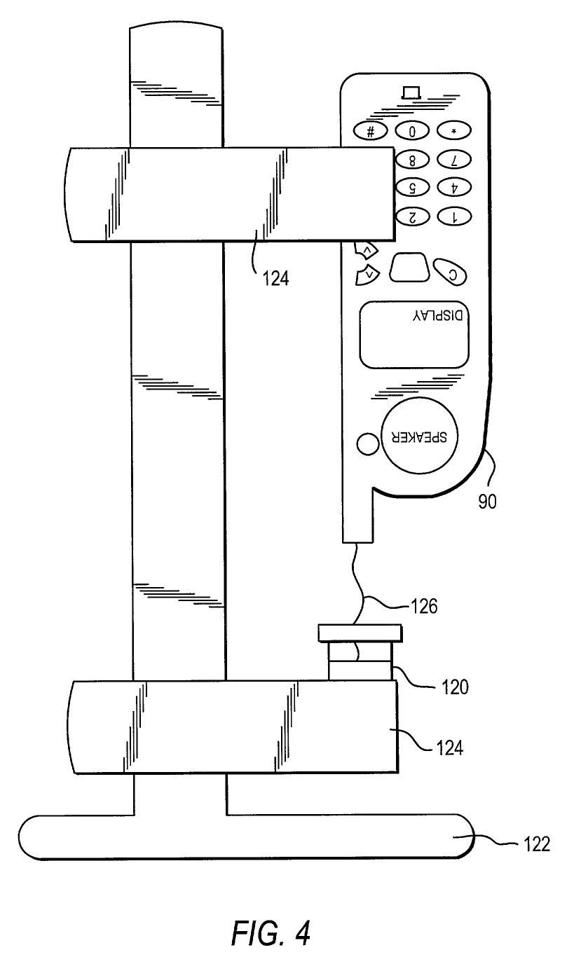

As shown in FIG. 4, the viability of human peripheral blood lymphocytes was examined by fixing cellular telephone 90 over a vial of blood lymphocytes 120 using a ring stand 122 and clamps 124. In some embodiments, the viability of the human peripheral blood lymphocytes was tested by physically connecting one end of a wire 126 (preferably a gold wire) into antenna 92 (FIG. 2) and the other end of the wire into vial 120.

The first vial of human peripheral blood lymphocytes was exposed to a cellular telephone (a Philips C12 GSM cellular telephone) that was charged and set on standby (“Positive Control”). The second vial of human peripheral blood lymphocytes was exposed to the cellular telephone having four of the radiation protection devices affixed to the cellular telephone as shown in FIG. 3 (“Protected by G-wave”). Similar to the Positive Control exposure, the cellular telephone was charged and set on standby. The third vial of human peripheral blood lymphocytes was exposed to the cellular telephone. However, the cellular telephone was not turned on (i.e., no electromagnetic radiation) (“Sham-Exposed”). The fourth vial of human peripheral blood lymphocytes was placed into a double skinned mu-metal container. It should be noted that mu-metal is a high permeability material that deflects magnetic fields, thereby creating an environment free of all radiation (“Negative Control”).

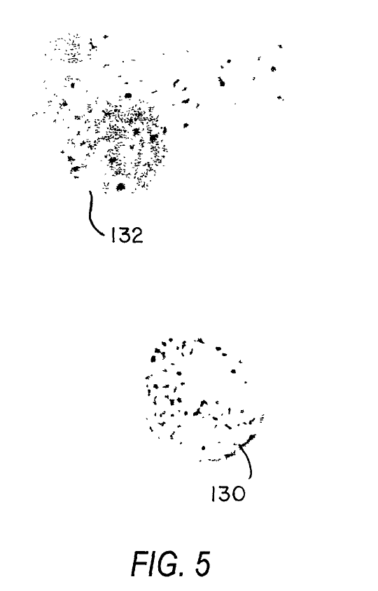

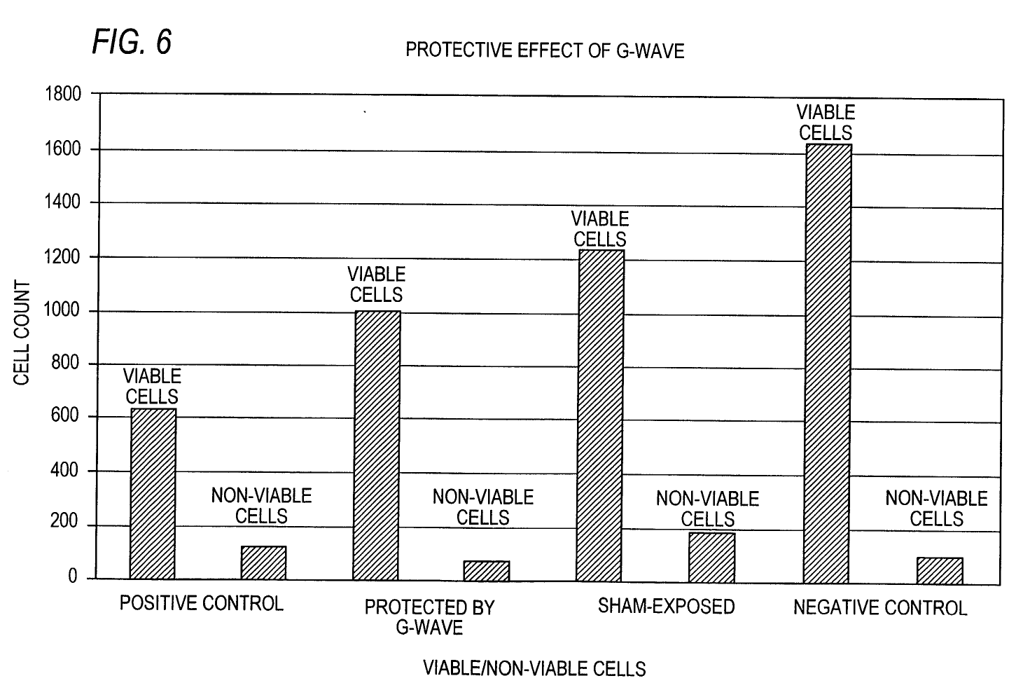

After exposing the four vials of human peripheral blood lymphocytes to electromagnetic radiation as described, the lymphocytic cells were microscopically examined. For example, Trypan Blue dye may be placed into each vial. The viable lymphocytic cells were quantified using a Trypan Blue exclusion assay, which measures the loss of cytoplasmic membrane integrity. Thus, the non-viable cells are stained and may be manually counted as shown in FIG. 5. FIG. 5 shows a viable cell 130 and a non-viable cell 132 that was stained using Trypan Blue. The lymphocytic cells were then counted to determine which cells have unruptured membranes (i.e., which cells are structurally viable) and which cells are non-viable. In this example, the lymphocytic cells were counted using a Sigma Brightline hemacytometer. Accordingly, Table 1 and FIG. 6 illustrate the correlation between using the radiation protection device and the viability of human peripheral blood lymphocytes.

TABLE 1
Cell counts of viable and non-viable human peripheral blood lymphocytes under
various conditions.

| | | Positive Control | | Protected by G-wave | | Sham-Exposed | | Negative Control | |
|---|---|---|---|---|---|---|---|---|---|
| | Run | Viable | Nonviable | Viable | Nonviable | Viable | Nonviable | Viable | Nonviable |
| | 1 | 64 | 15 | 97 | 6 | 126 | 16 | 132 | 5 |
| | 2 | 44 | 8 | 129 | 7 | 115 | 19 | 158 | 7 |
| | 3 | 75 | 6 | 106 | 7 | 122 | 21 | 161 | 11 |
| | 4 | 68 | 8 | 95 | 12 | 134 | 18 | 179 | 10 |
| | 5 | 44 | 10 | 93 | 5 | 117 | 12 | 166 | 9 |
| | 6 | 78 | 8 | 92 | 8 | 125 | 30 | 172 | 12 |
| | 7 | 69 | 7 | 118 | 9 | 117 | 14 | 184 | 15 |
| | 8 | 65 | 28 | 121 | 8 | 128 | 22 | 153 | 6 |
| | 9 | 81 | 19 | 67 | 4 | 131 | 25 | 162 | 8 |
| | 10 | 47 | 12 | 86 | 6 | 120 | 13 | 168 | 9 |
| Total | | 635 | 121 | 1004 | 72 | 1235 | 190 | 1635 | 92 |
| Mean | | 63.50 | 12.10 | 100.40 | 7.20 | 123.50 | 19.00 | 163.50 | 9.20 |
| Standard Deviation | | 13.88 | 6.89 | 18.48 | 2.25 | 6.38 | 5.68 | 14.53 | 2.97 |
| % Viable | | 83.99 | | 93.31 | | 86.67 | | 94.67 | |

FIG. 6 shows an illustrative bar graph in which the results of the Trypan Blue exclusion assay were quantified. FIG. 6 further shows the viability of human peripheral blood lymphocytes after the various exposure conditions as described above. As is evident from Table 1 and the bar graph shown in FIG. 6, the viability of human peripheral blood lymphocytes correlates strongly with the use of radiation protection device 110. Therefore, device 110 has a significant protective effect on the viability of lymphocytes.

Thus, it is seen that a radiation protection device that generates gravitational waves may be used with a cellular telephone to protect a user against possible deleterious effects of electromagnetic radiation. One skilled in the art will appreciate that the invention can be practices by other than the described embodiments, which are presented for purposes of illustration and not of limitation, and the invention is limited only by the claims which follow.

What is claimed is:

1. A device for protecting a user against electromagnetic radiation from a cellular telephone, the device comprising:
a ceramic material affixed to the cellular telephone, wherein the ceramic material:
absorbs gravitational waves from the surrounding environment;
amplifies the absorbed gravitational waves within the ceramic material; and
emits the amplified gravitational waves to alter the electromagnetic radiation emitted from the cellular telephone.

2. The device of claim 1 wherein the ceramic material is affixed to the cellular telephone using a binding agent.

3. The device of claim 1 wherein the ceramic material comprises a piezoelectric ceramic.

4. The device of claim 1 wherein the ceramic material comprises a ceramic ferrite.

5. The device of claim 1 wherein the ceramic material has a diameter of about 4 mm.

6. The device of claim 1 wherein the ceramic material has a depth of about 2 mm.

7. The device of claim 1 wherein the ceramic material is affixed to each corner of the cellular telephone.

8. The device of claim 1 wherein the ceramic material is further configured to filter out the electromagnetic radiation emitted from the cellular telephone.

9. A method for protecting a user against electromagnetic radiation from a cellular telephone, the method comprising:
affixing a ceramic radiation protection device to the cellular telephone;
absorbing gravitational waves from the surrounding environment using the ceramic radiation protection device;
amplifying the absorbed gravitational waves using the ceramic radiation protection device; and
emitting the amplified gravitational waves to alter the electromagnetic radiation emitted from the cellular telephone using the ceramic radiation protection device.

10. The method of claim 9 wherein the affixing further comprises affixing the ceramic radiation protection device to the cellular telephone using a binding agent.

11. The method of claim 9 wherein the ceramic radiation protection device comprises a piezoelectric ceramic.

12. The method of claim 9 wherein the ceramic radiation protection device comprises a ceramic ferrite.

13. The method of claim 9 wherein the ceramic radiation protection device is affixed to each corner of the cellular telephone.

14. The method of claim 9 wherein the emitting further comprises filtering out the electromagnetic radiation emitted from the cellular telephone.

15. A device for protecting a user against electromagnetic radiation from a cellular telephone, the device comprising:
means for affixing a radiation protection device to the cellular telephone;
means for absorbing gravitational waves from the surrounding environment;
means for amplifying the absorbed gravitational waves; and
means for emitting the amplified gravitational waves to filter out the electromagnetic radiation emitted from the cellular telephone.

16. A device for protecting a user against electromagnetic radiation from an electronic device, the device comprising:
a ceramic material affixed to the electronic device, wherein the ceramic material:
absorbs gravitational waves from the surrounding environment;
amplifies the absorbed gravitational waves within the ceramic material; and
emits the amplified gravitational waves to alter the electromagnetic radiation emitted from the electronic device.

17. The device of claim 16 wherein the electronic device is a cellular telephone.

18. The device of claim 16 wherein the electronic device is a personal computer.

19. The device of claim 16 wherein the electronic device is a personal digital assistant.

20. The device of claim 16 wherein the electronic device is a television.

21. The device of claim 16 wherein the ceramic material is affixed to the cellular telephone using a binding agent.

22. The device of claim 16 wherein the ceramic material comprises a piezoelectric ceramic.

23. The device of claim 16 wherein the ceramic material comprises a ceramic ferrite.

24. The device of claim 16 wherein the ceramic material has a diameter of about 4 mm.

25. The device of claim 16 wherein the ceramic material has a depth of about 2 mm.

26. A method for protecting a user against electromagnetic radiation from an electronic device, the method comprising:
affixing a radiation protection device to the electronic device;
absorbing gravitational waves from the surrounding environment using the radiation protection device; and
emitting the amplified gravitational waves to alter the electromagnetic radiation emitted from the electronic device using the radiation protection device.

27. The method of claim 26 wherein the electronic device is a cellular telephone.

28. The method of claim 26 wherein the electronic device is a personal computer.

29. The method of claim 26 wherein the electronic device is a personal digital assistant.

30. The method of claim 26 wherein the electronic device is a television.

31. The method of claim 26 wherein the radiation protection device comprises a piezoelectric ceramic.

32. The method of claim 26 wherein the radiation protection ceramic comprises a ceramic ferrite.

33. The method of claim 26 wherein the emitting further comprises filtering out the electromagnetic radiation emitted from the cellular telephone.

34. A device for protecting a user against electromagnetic radiation from an electronic device, the device comprising:
a ceramic material affixed to the electronic device, wherein the ceramic material:
absorbs gravitational waves from the surrounding environment; and
emits the absorbed gravitational waves to filter out the electromagnetic radiation emitted from the electronic device.

35. A method for protecting a user against electromagnetic radiation from an electronic device, the method comprising:
affixing a ceramic radiation protection device to the cellular telephone;
absorbing gravitation waves from the surrounding environment using the ceramic radiation protection device; and
emitting the absorbed gravitational waves to filter out the electromagnetic radiation emitted from the electronic device.
